(19) United States
(12) Patent Application Publication
(10) Pub. No.: US 2008/0256889 A1
(43) Pub. Date: Oct. 23, 2008

(54) Joining Element for Joining Two Workpieces

(76) Inventors: Sammuel Haenni, Rothrist (CH); Patrick Jeker, Brislach (CH)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/101,352

(22) Filed: Apr. 11, 2008

(30) Foreign Application Priority Data
Apr. 13, 2007 (CH) 0615/07

(51) Int. Cl. E04B 1/38; B32B 7/08

(52) U.S. Cl. 52/578; 156/92

(57) ABSTRACT

A joining element (21) for joining two workpieces (1, 3), which each are provided at the ends thereof with a groove (11, 13), the grooves being aligned with one another for joining at the contact surfaces, has a disk-like configuration and is dimensioned such that it can be driven or stricken into the grooves. On the lateral surfaces, the disk-like element comprises rib-like elevations (23, 25) extending substantially in the driving direction, wherein the elevations, viewed in the driving direction and from the connection of the two workpieces, are configured to converge obliquely or in a curved manner at least along one section.

### TECHNICAL FIELD

The present invention relates to a joining element for joining two workpieces and to a method of using the joining element.

### BACKGROUND AND SUMMARY

A plurality of possibilities are known for joining two workpieces. In addition to joining means disposed directly in the workpieces, it is also possible to join them by means of external elements, such as hooks, protruding brackets, snap-fit elements, screw connections, corrugated fasteners, and the like.

It is the object of the present invention to create a joining element, which enables a stable and reliable connection of two workpieces in a simple manner. In addition to the ease of use or application, the element as such should also be easy and cost-efficient to produce.

According to the invention, a joining element comprises a disk-like element having at least two rib-like elevations in at least one lateral surface, the elevations being configured to diverge obliquely or arched at least along one section.

The inventive joining element for joining two workpieces has a disk-like or plate-like design, comprising on at least one lateral surface at least two rib-like elongated elevations, which are configured such that they converge obliquely, at an angle and/or arched in relation to one another at least along one section.

In the two workpieces to be joined, grooves are provided at the ends or in the directions of the connection, which is to say the contact surface, the grooves being aligned with one another, and the disk-like or plate-like element is provided in order to be driven or stricken into the grooves for joining purposes, wherein the at least two rib-like elements are configured to extend substantially in the driving direction.

According to one embodiment, rib-like elevations are provided on both lateral surfaces of the disk-like element, wherein the rib-like elevations, viewed from the connection of the two workpieces, are configured to converge or diverge in the driving direction. It is apparent that always at least one of these rib-like elevations is configured on the disk-like element such that it runs in one of the two grooves of the two workpieces.

According to one embodiment, the rib-like elevations, viewed in the driving direction, are configured such that they diverge from each other in the lower region of the disk-like element.

The rib-like elevations can either be configured to protrude evenly from the lateral surface or, viewed in the longitudinal direction, can be interrupted at least in sections in certain locations. The rib-like elevations can also be configured such that they extend in a quasi wedge-shaped or conical manner in the driving direction, which is to say the height thereof in the driving direction is tapered toward the bottom edge of the joining element.

According to another embodiment, the rib-like elevations can be configured interrupted in a serrated manner, comprising serrations preferably directed opposite to the driving direction in order to prevent the element from breaking out of the groove. The rib-like elevations are self-tapping.

Preferably directly adjacent to the rib-like elevations, it is also possible that rib-like depressions are configured along the ribs in order to receive material displaced by the ribs in the groove walls during the driving operation.

Finally, further hook-like elements may be provided on the lateral surfaces of the disk-like elements.

The basic shape of the disk-like or plate-like joining element is substantially free and the element may be, for example, rectangular, circle segment-shaped, triangular and the like, and particularly viewed in the driving direction, the bottom edge of the element can be arched, oval, elliptic, angular, substantially straight and the like.

The joining element can be made of a wide variety of materials, such as plastic, metal, wooden materials, wooden composites, or combinations thereof. With reference to the attached figures, a variety of possible shapes of the joining elements and of the rib-like elevations are described in more detail hereinafter.

Furthermore, a method for joining two workpieces is proposed, wherein a groove is provided in each of the two workpieces to be joined at the ends thereof in the joining direction, which is to say in the direction of the contact surface, the grooves being aligned with one another. For the joining operation, a disk-like or plate-like element is driven or stricken into the two grooves aligned with one another, wherein as a result of the special configuration of the rib-like elevations the two workpieces to be joined are pressed together on the contact surface transversely to the driving direction. It is apparent that the depth of the grooves must correspond at least to the driving depth of the disk-like element.

Further preferred embodiments of both the joining element and the method are disclosed below.

The invention will be explained in more detail by way of examples and with reference to the enclosed figures.

### BRIEF DESCRIPTION OF DRAWINGS

FIG. 1 is a schematic, perspective illustration of the joining of two workpieces by means of an elongated, substantially rectangular joining element comprising a rounded bottom edge,

FIG. 2 is a schematic, perspective illustration of the joining of two workpieces by means of a joining element configured differently,

FIG. 3 shows the joining of two workpieces in a corner region by means of an angular joining element,

FIGS. 4a-d show, respectively, a side view, top view, longitudinal section and side perspective of a joining element according to the invention,

FIGS. 5a-d show, respectively, side and top views, a cross-sectional view as well as a side perspective of a further embodiment of a joining element,

FIG. 6 is a further embodiment of a joining element in a longitudinal section, similarly to the illustration according to FIG. 4c,

FIGS. 7a-d are perspective views of examples of further embodiments of a joining element,

FIGS. 8a-f are perspective views of further examples of further embodiments of a joining element, and

FIGS. 9a-c are perspective views of examples of rib-like elevations on a joining element.

### DETAILED DESCRIPTION

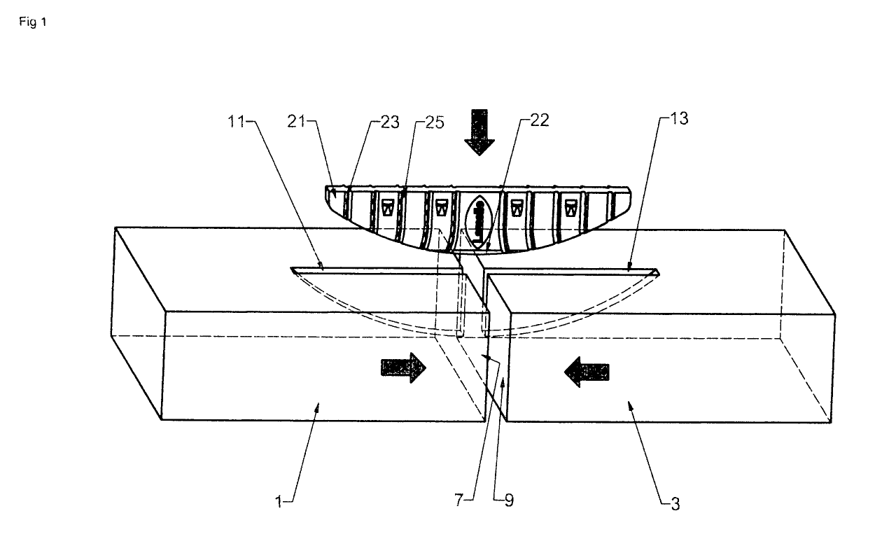

FIG. 1 shows a lateral perspective view of the joining of two workpieces 1 and 3, which each are provided with a groove 11 and 13. In order to join the two workpieces 1 and 3, an elongated disk-like joining element 21 is provided, which comprises rib-like elevations 23 and 25 on either side. Viewed from the center, these rib-like elevations are configured to diverge from one another, preferably in the end region viewed in the driving direction, which is to say in the region of the lower edge 22 of the element.

The joining element according to FIG. 1 has a rounded or arched bottom edge 22. This is in no way absolutely required, which is to say the bottom edge can also be configured to be straight, trapezoidal, triangular and the like.

In order to join the two workpieces 1 and 3 such that they abut with the front surfaces 7 and 9 thereof, the joining element is driven into the two grooves 11 and 13 in the direction of the arrow, wherein as a result of this driving operation the two workpieces to be joined are pressed together transversely to the driving direction. The pressing action is applied by the protruding ribs 23 and 25 on the joining element due to the special configuration of the ribs and the curvature, which is configured substantially parallel to the driving direction and such that arched divergence is achieved in the lower region. The divergence of the ribs at the ends creates the pressing action. The gap can be joined with or without adhesive.

The special characteristic of this joining connection is that the pressing action is not only applied to the surface, but above all on the inside of the gap and thus is distributed across the entire depth of the gap and the contact surface.

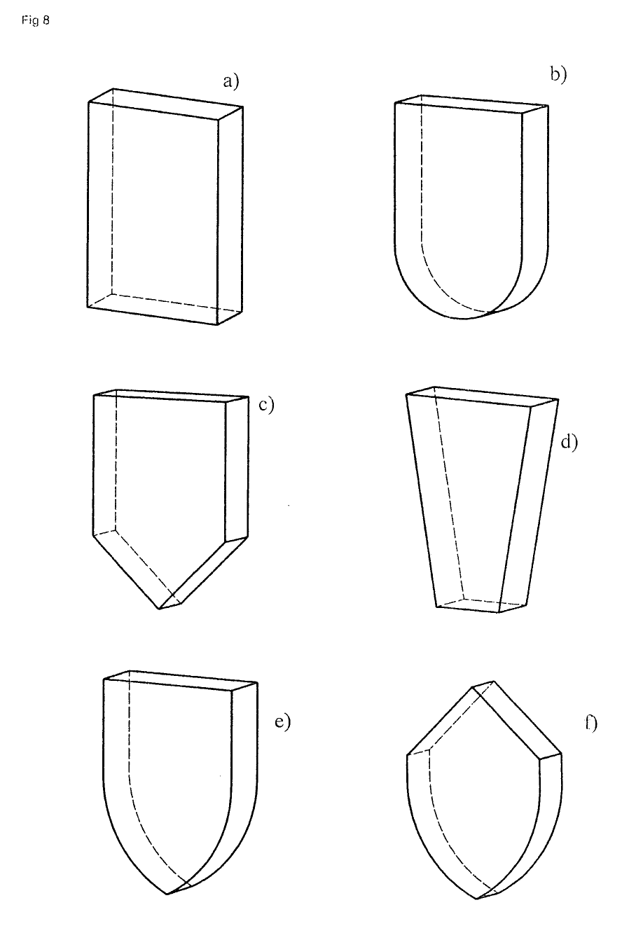

The selection of the basic shape of the joining element is completely free, and the element can be configured to be rectangular, circle segment-shaped, triangular and the like, for example, or it may take on other shapes. The same also applies to the lower edge 22 of the joining element, viewed in the driving direction, wherein the edge can be straight, arched, serrated, wedge-shaped and the like. In the illustration according to FIG. 1, this bottom edge 22 has an arched configuration. The thickness of this element is also not limited. A plurality of examples of possible shapes are shown schematically in FIGS. 8a-f.

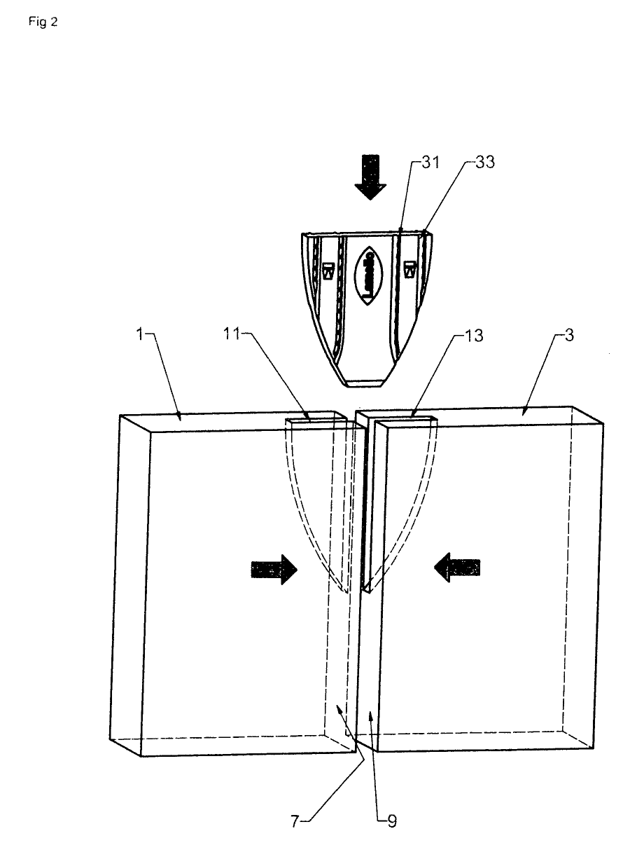

Accordingly, FIG. 2 shows the perspective illustration of the joining of two workpieces 1 and 3 by driving a further disk-like joining element 31 into the two grooves 11 and 13 aligned with one another. The joining element 31 is again provided with the rib-like elevations 33, which are configured parallel to the driving direction and at the ends are configured to diverge in the driving direction.

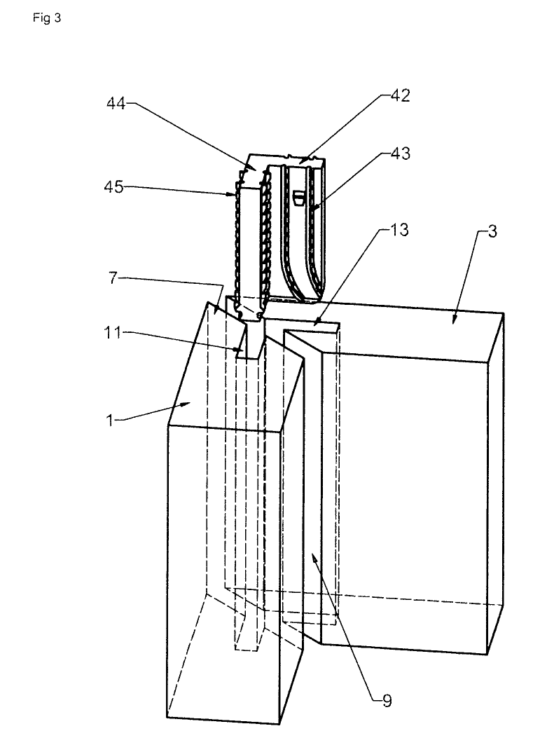

Viewed from a top view, the joining element, however, may also be angled, as is shown in a schematical top view, for example, in FIG. 3, where a corner connection of two workpieces 1 and 3 is illustrated. A joining element 41, which in this example has an angular design, is again driven into the two grooves 11 and 13, which are configured in the corner region of the two workpieces 1 and 3 to be joined such that they are aligned with or abut each other. As a result of the rib-like elevations 43 and 45 configured in the two legs 42 and 44 of the joining element, the pressing action is again applied to the contact surfaces 7 and 9 when driving the element into the grooves 11 and 13.

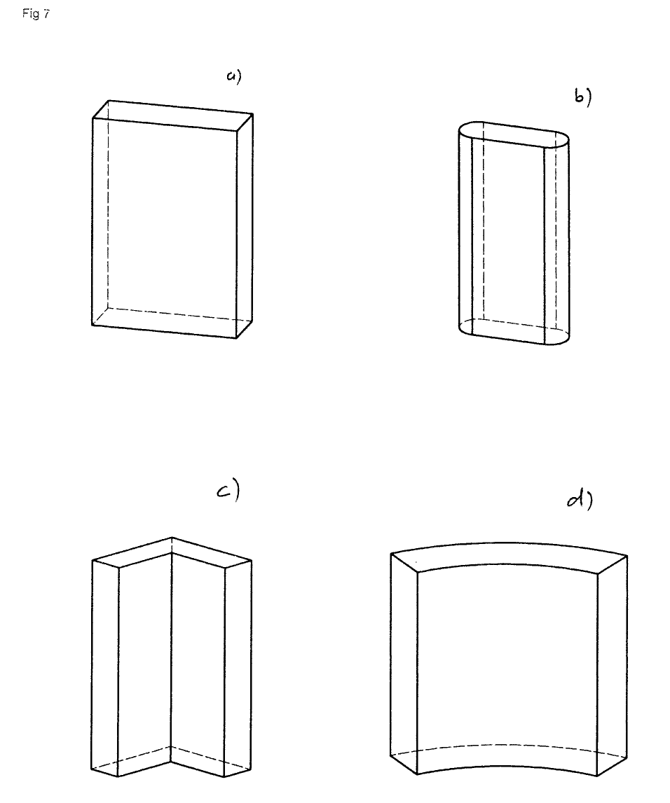

Similar to an angular connection, of course also two workpieces that are round in a top view can be joined in that the joining element (viewed from above) is configured in a pipe segment or ring segment shape. Also a connection of an angular workpiece to a straight workpiece, or of a round workpiece to an angular workpiece, and the like, can be achieved by means of a disk-like joining element proposed according to the invention. The essential aspect is that the disk-like joining element is aligned with the groove shapes produced in the respective workpieces. Examples of possible shapes are shown in FIGS. 7a-d.

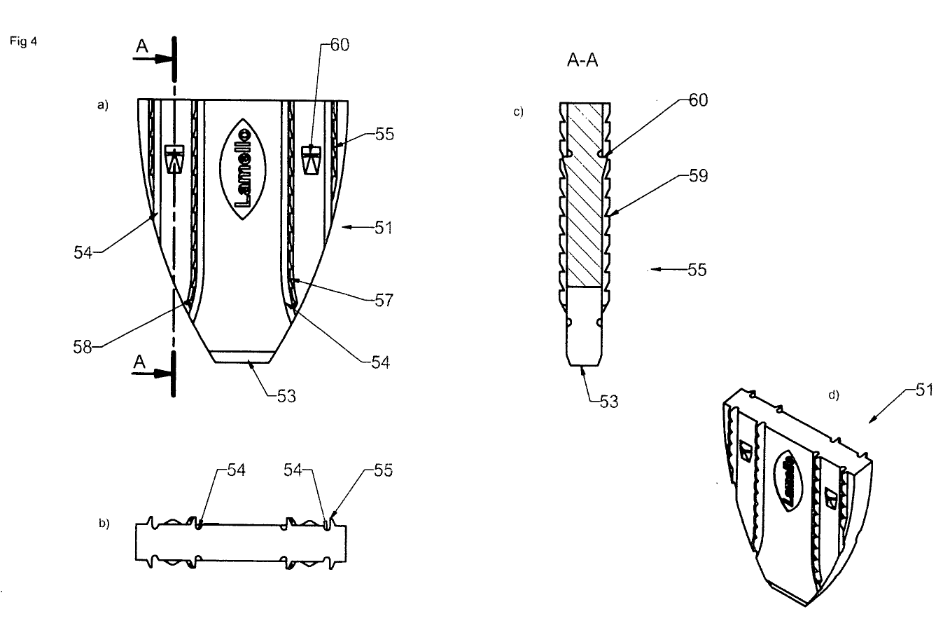

FIG. 4 illustrates a possible shape of a disk-like joining element 51 in four different views. FIG. 4a shows a side view of the disk-like element 51, which, viewed in the driving direction, is configured to converge in an oval or elliptic manner, comprising a straight flattened lower front section 53. Two rib-like elevations 55 are provided symmetrically on the left and right, the elevations, viewed in the driving direction, extending substantially parallel to one another. It is clearly apparent that, viewed in the driving direction, at least two rib-like elevations are provided at the ends along the sections 57 and 58, for example such that they diverge in an arched or angled manner in order to generate the pressing action on the contact surfaces of the workpieces when driving the element 51 into the grooves of the workpieces.

Furthermore, additional hook elements 60 are provided in the visible lateral surface, wherein the elements are intended to prevent the disk from breaking out of the grooves.

FIG. 4b shows the disk according to FIG. 4a from above, viewed in the driving direction, and FIG. 4c shows a longitudinal section along line A-A from FIG. 4a. As is apparent particularly from FIG. 4, in addition to the ribs 55 also rib-like depressions 54 are provided in the lateral surfaces of the disk 51, wherein the depressions are configured to directly abut the protruding ribs 55. The advantage of these rib-like depressions is that the material breaking away in the groove wall during the driving operation as a result of the ribs can be received by the channels. Since the driving step of the element is performed in a “self-tapping” manner by the protruding ribs, material is removed or displaced from the lateral groove walls. It is also clearly apparent from FIG. 4c that the rib-like elevations 55 are interrupted in a serrated manner in the longitudinal direction by the formation of individual, laterally protruding hooks 59. The hooks are configured to protrude opposite to the driving direction in order to prevent the joining element from breaking out of the grooves.

Finally, FIG. 4d shows a side perspective of the disk-like element.

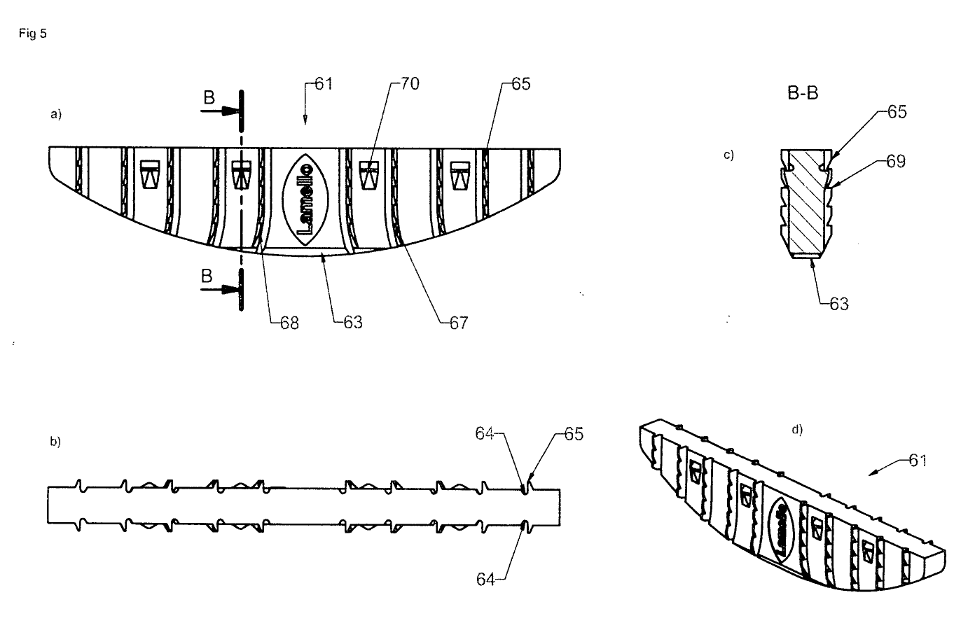

Similarly, FIGS. 5a to 5d show a further embodiment of a disk-like joining element 61, comprising rib-like elevations 65 configured parallel to the driving direction, wherein at least a portion of these ribs comprises diverging sections 67 and 68 at the ends, viewed in the driving direction. The disk-like element 61 according to FIG. 5, viewed in the driving direction, has a substantially arched front section 63. The lateral surface is again provided with hook-like elements 70 in order to prevent the element from breaking out. FIGS. 5b to 5d show similar illustrations to those of FIGS. 4b to 4d.

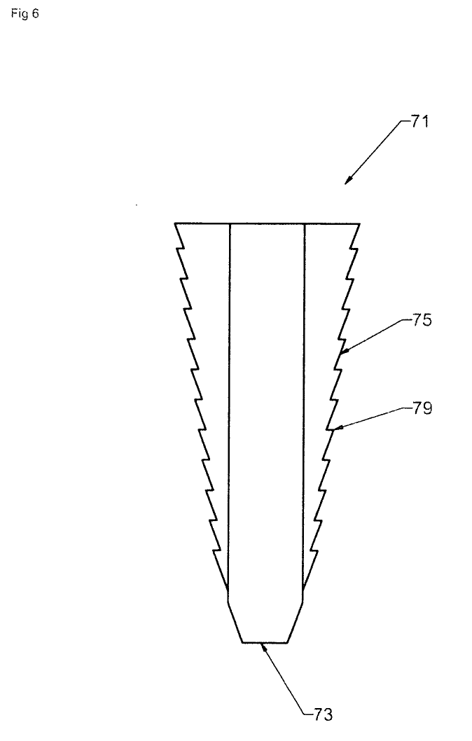

Similar to the illustrations according to FIGS. 4c and 5d, FIG. 6 shows a longitudinal section along an inventive joining element in the region of a rib-like elevation. Unlike the above-described joining elements, the joining element 71 according to FIG. 6 comprises laterally protruding rib-like elevations 75, which, viewed in the driving direction, are configured to converge conically or to converge in a substantially wedge-shaped manner. In other words, the height of the ribs in the front region or in the region of the lower edge 73 is less than the height of the ribs in the upper region of the element 71. The ribs 75 again have a serrated configuration, comprising hooks 79 directed opposite to the driving direction in order to prevent the element from breaking out of the groove.

As already mentioned with reference to FIG. 3, the disk-like or plate-like joining elements do not have to be configured plane and elongated, but instead may also be configured to be angled, arched or differently with respect to the longitudinal extension, depending on how the grooves in the two workpieces to be joined are dimensioned and/or configured, which is shown schematically in FIGS. 7a-d.

FIGS. 8a to 8f illustrate further embodiments of disk-like or plate-like joining elements. Of course this is only a selection, and the inventive joining disks may take on different or combined shapes.

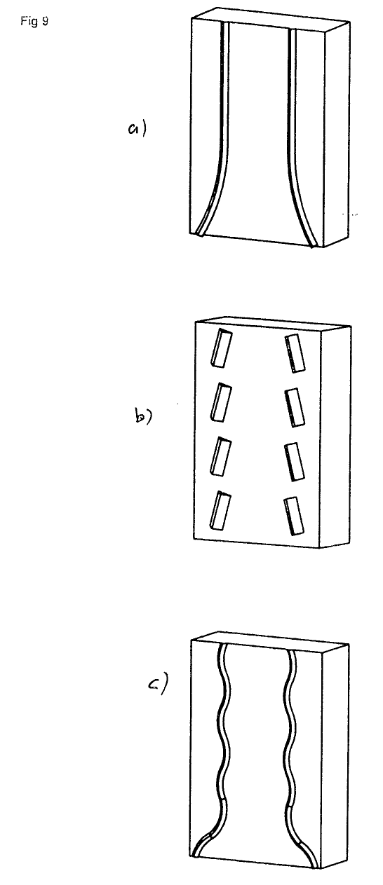

Finally, the rib-like elevations do not have to be continuous, but instead they can also be interrupted, arched, serrated, as mentioned above, and the like. In this respect, reference is made to FIGS. 9a-9c, which show possible examples of rib-like elevations.

The examples of plate-like or disk-like joining elements, rib-like elevations, and the like, illustrated with reference to FIGS. 1 to 9 are, of course, only examples that are used to provide a better explanation of the present invention. Variations and modifications of the joining elements and of the rib-like elevations are possible, the only essential aspect is that at least on one lateral surface at least two rib-like elevations are provided, which are configured to diverge obliquely or arched at least along one section.

The disk-like joining element can be driven or stricken most easily, for example, by means of a hammer or another driving tool. Two workpieces, however, can also be joined mechanically in that such joining elements are driven by a machine into the respective grooves of the workpieces to be joined.

Unlike conventional joining elements, such as dovetail connections, which require complex interlocking reaming in the workpieces to be joined, this system only requires a regular groove. Or contrary to corrugated fasteners, which necessitate a complex power-driving tool, a simple hammer suffices with this system.

In other words, the object mentioned at the beginning is achieved in a very simple and efficient manner by the joining element proposed according to the invention.

1. A joining element for joining two workpieces (1, 3), comprising a disk-like element (21, 31, 41, 51, 61) having at least two rib-like elevations (23, 25, 33, 43, 45, 55, 65) in at least one lateral surface, the elevations being configured to diverge obliquely or arched at least along one section.

2. The joining element according to claim 1 for joining two workpieces (1, 3), each comprising a groove (11, 13) at the end, the grooves being aligned with each other for joining, wherein the disk-like element (21, 31, 41, 51, 61) is provided in order to be driven or stricken into the grooves for joining purposes and that the at least two ribs are substantially configured to extend in the driving direction.

3. A joining element according to claim 2, wherein the protruding rib-like elevations (23, 25, 33, 43, 45, 55, 65) are configured on both lateral surfaces of the element and, viewed from the connection or contact surface of the two workpieces in the driving direction, are configured to diverge at least along one section.

4. A joining element according to claim 2, wherein the rib-like elevations, viewed in the driving direction, are configured to diverge obliquely, angularly or in an arched manner, in the end region or in the region of the lower edge of the disk-like element.

5. A joining element according to claim 2, wherein the elevations are configured to be at least one of irregular, corrugated, and interrupted at least partially in the longitudinal extension.

6. A joining element according to claim 2, wherein the rib-like elevations are configured to protrude in varying degrees from the joining element and have varying shapes with a protruding edge which is at east one of serrated and arched.

7. A joining element according to claim 2, wherein the rib-like elevations are serrated, with serrations that are directed opposite to the driving direction in order to prevent the element from breaking out of or exiting the groove.

8. A joining element according to claim 2, further comprising at least one hook-like element disposed in the lateral surface or surfaces in order to prevent the element from breaking out of or exiting the groove.

9. A joining element according to claim 2, wherein the element, viewed in the longitudinal extension or from above, has a shape selected from the group consisting of straight, angled, arched and a combination thereof.

10. A joining element according to claim 2, wherein the disk-like element has a shape selected from the group consisting of rectangular, square, circle segment-shaped, and elliptic, and when viewed in the driving direction has a lower edge which is at least one of the group consisting of configured to converge in an oval or elliptic shape, is straight, wedge-shaped, angled, and circular.

11. A joining element according to claim 2, wherein the height of the rib-like elevations, viewed in the driving direction, is configured to converge substantially conically or wedge-shaped such that the height of the rib-like elevations in the region of the bottom edge of the disk-like element is smaller than the height in the upper region.

12. A joining element according to claim 2, wherein the disk-like element is made of a material selected from the group consisting of a metal a polymer or plastic, wood, a wooden composite, and combination thereof.

13. A method for joining two workpieces by means of a joining element according to claim 2, comprising milling grooves which can be aligned with one another into the ends of the workpieces to be joined in the direction of the connection or contact surface, wherein the two grooves are dimensioned in accordance with the joining element such that the joining element requires a force to be driven into the grooves, and, with the grooves aligned with one another, driving the joining element into the grooves to join the two workpieces.

14. The method according to claim 13, wherein after the grooves have been produced, the joining element is driven into the grooves using and wherein during the driving operation the two workpieces to be joined or the contact surfaces thereof are pressed together transversely to the driving direction.

15. The method according to claim 13, wherein after the grooves have been produced, the joining element is driven into the grooves mechanically using a machine, and wherein during the driving operation the two workpieces to be joined or the contact surfaces thereof are pressed together transversely to the driving direction.
